(19) United States
(12) Patent Application Publication
(10) Pub. No.: US 2009/0209404 A1
(43) Pub. Date: Aug. 20, 2009

(54) Mechanism for generating directional thrust from a centrifuge

(76) Inventor: Roger L. Greene, La Veta, CO (US)

Correspondence Address: Roger L. Greene, P.O. Box 1053, La Veta, CO, 81055, US

(21) Appl. No.: 12/070,147

(22) Filed: Feb. 15, 2008

(51) Int. Cl. B04B 9/06

(52) U.S. Cl. 494/84

(57) ABSTRACT

A mechanism for generating directional thrust from a centrifuge, related to an engine that includes; a framework (2) that supports an axle (1) upon which a rotor (3) spins. Ballasted truck assembly (5) is put in motion by energy control (6) to move back and forth on a track (3a) in such a way that the force of the spinning rotor is consistently altered to be greater on one side of an axle than the other, thereby imputing thrust to the axle and framework and enabling force or travel in XYZ planes without need of a drive mechanism to act upon a surface or atmosphere.

### CROSS-REFERENCE TO RELATED APPLICATIONS

Not applicable.

### BACKGROUND OF THE INVENTION

1. Field of Invention

This invention relates to propulsion, specifically to utilize the forces of inertia generated within a centrifuge to produce directional thrust.

2. Discussion of Prior Art

Centrifugal imbalance has long been considered a destructive and undesirable effect for any spinning mechanism. Great care is taken to balance motors, shafts, gears, wheels and the like. Imbalance creates unusually high stresses on axles and generates a great deal of typically destructive energy. A common form of centrifugal imbalance, such as an out-of-balance tire, for instance, causes a bumping effect on a vehicle at higher speeds. The stresses cause extraordinary wear on the tire tread and are damaging to suspension components. Typically, the weight needed to counterbalance and achieve smooth operation is very small. This attests to the power generated by even a small centrifugal imbalance on a relatively slow moving centrifuge.

Occasionally, such an imbalance is desirable in order to create a vibrating effect. This is useful for vibrating alerts in pagers or phones. U.S. Pat. No. 6,326,711 to Yamaguchi (2001) shows an eccentric rotor affixed to a small motor to create vibration as a signal. This type of device is also useful for massaging devices and compacting devices. In these cases, a non-directional imbalance is generated whereby the imbalance is equal on 360 degrees of the rotation of the lobe or gear creating the imbalance.

The prior art depicts several methods of correcting imbalance, such as U.S. Pat. No. 7,285,085 to Kim (2007) where a rotor is designed to automatically compensate for imbalance by radial extension and retraction of a weight. U.S. Pat. No. 4,157,781 to Marayama shows a self-balancing centrifuge wherein fluid is pumped from buckets on opposite ends of a centrifuge to achieve balance.

A related balancing device, U.S. Pat. No. 4,517,822 to Bigret (1985), induces a non-directional imbalance to a rotor by releasing fluid from reservoirs that keep it in balance as a diagnostic and labor-saving tool used to achieve balance.

U.S. Pat. No. 7,255,669, to Takahiro (2007), is an imbalance detection device designed to shut off power to a centrifuge when the extent of pull or vibration exerted on a spindle exceeds a limit. This kind of device is critical to protect equipment driving a fast-turning rotor.

The prior art shows several means for arresting imbalance, eliminating imbalance or creating it non-directionally. It does not show an instance whereby an imbalance is created and maintained in an omni-directional mode. This concept has been remarkably overlooked for a very long time.

Using the analogy of the vehicle tire that is out-of-balance, consider the stress of the imbalance exerted on the spindle or axle of the wheel. The part of the wheel that is heavier creates a pulling force greater than that of the rest of the wheel. It does so during the entire rotation of the wheel. The bumping sensation felt in the vehicle is primarily due to a small degree of lift generated when the heavier part of the wheel passes over the top of the axle.

The G forces created in a centrifuge can be enormous. Even on the small scale of the vehicle tire, the effect on a relatively slow moving orbit is enough to shake a two-ton vehicle.

If an imbalance is created and maintained on only one side of a centrifuge axle, the axle will then pull consistently toward the greater force. The prior art does not show an application whereby an imbalance is created and maintained on a particular side of an axle axis to induce a directional thrust.

The prior art shows a variety of methods to achieve balance or non-directionally induce an imbalance. The prior art does not show a means of creating a centrifugal imbalance that can create an omni-directional thrust.

### SUMMARY

The mechanism for generating directional thrust from a centrifuge of the present invention, utilizes a means whereby the inertia of components of a rotor are manipulated to create force on a particular plane of an axle, thereby imputing directional thrust to the axle. The present invention is groundbreaking in terms of tapping the potential produced on an axle when a rotating mass is subjected to a specific state of imbalance.

There is no consideration in the prior art of utilizing a centrifuge for any purpose other than spinning materials to achieve sedimentation. The prior art presented deals with imbalance issues to the effect of correcting balance and protecting machinery. The currently considered useful potential of centrifugal imbalance is limited to its use a means of producing vibration. The manipulation of imbalance of a centrifuge to create directional thrust remains overlooked as does its usefulness in the field of propulsion.

The present invention shows how to generate thrust from a centrifuge that is independent of a drive mechanism. Subsequently, no atmosphere or surface is required to achieve propulsion. This invention harvests rotational energy in a novel and unexpected method.

### OBJECTS AND ADVANTAGES

Accordingly, the objects and advantages of the mechanism for generating directional thrust from a centrifuge described in my above patent, several other advantages of the present invention are:
a) to generate force and thrust without regard to plane of operation.
b) to provide a means of thrust that does not act on an atmosphere.
c) to provide a means of thrust that does not act on a surface.
d) to provide a means of extracting propulsion or force from simple rotation.
e) to provide a means of lift that does not require a propeller or rotating wing.
f) to provide a means of lift that does not require the explosion of fuels for rockets or jets.
g) to provide a potentially quiet means of propulsion or lift.
h) to provide a means of braking or change of direction without interaction of an atmosphere.
i) to provide a means of braking or change of direction without interaction of a surface.
j) to provide a means of increasing weight beyond gravitational forces.
k) to provide a means of elevation.
l) to provide a means of levitation.

### DRAWING FIGURES

In the drawings, closely related figures have the same number, but different alphabetic suffixes.

FIG. 1 shows a top view of the preferred embodiment.

FIG. 2 shows a top view of the first alternative embodiment.

FIG. 3 shows a top view of the second alternative embodiment.

### REFERENCE NUMERALS IN DRAWINGS

1. axle
2. framework
3. rotor
3a. track
3b. geared rack
3c. drive gear
4. rotational motor
5. ballasted truck assembly
5a. truck motors
5b. pinion gear
6. energy control
7. energy source

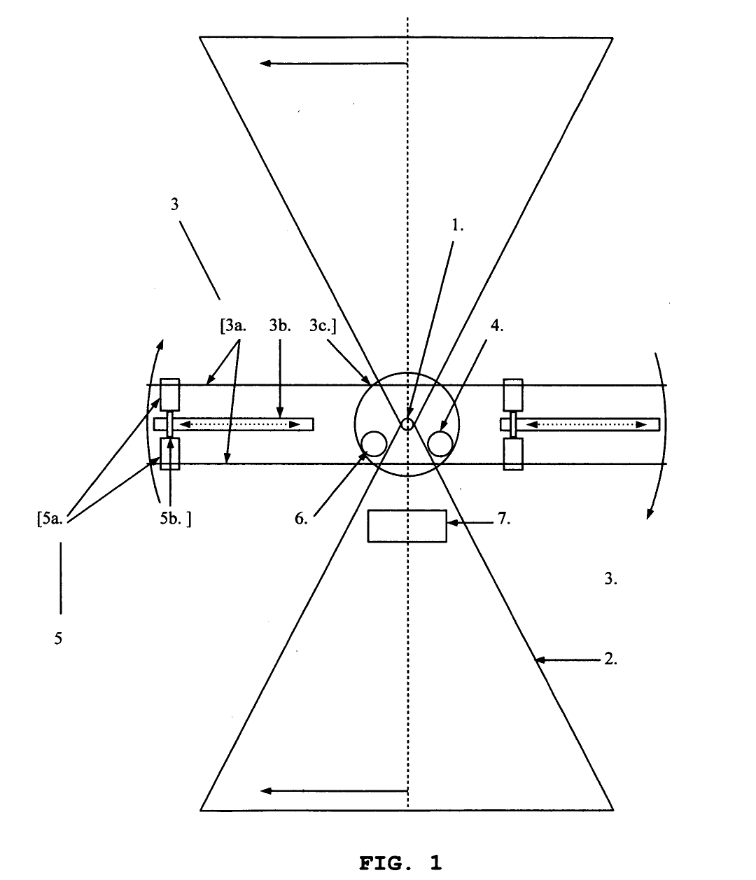

### DETAILED DESCRIPTION—PREFERRED EMBODIMENT—FIG. 1

The preferred embodiment of the present invention is illustrated in FIG. 1, a top view of the device. Axle 1 is located centrally on framework 2. Rotor 3 consists of track 3a and geared rack 3b. Drive gear 3c is central to rotor 3. Rotational motor 4 is located adjacent to drive gear 3c. Ballasted truck assembly 5 consists of truck motors 5a and pinion gear 5b. Energy control 6 and energy source 7 are located near the center of framework 2.

### Operation—FIG. 1—Preferred Embodiment

In FIG. 1, circular arrows indicate direction of motion of rotor 3 on axle 1. Framework 2 supports axle 1. Rotational motor 4 and energy source 7 are also affixed to framework 2. Drive gear 3a of rotor 3 engages rotational motor 4. Energy source 7 energizes rotational motor 4 as well as energy control 6. Energy control 6 supplies power to truck motors 5a of ballasted truck assembly 5. Pinion gear 5b engages geared rack 3b. Track 3a supports and guides truck assembly 5. Dotted arrows show motion of ballasted truck assembly 5 on rotor 3. Dashed line dissecting axle 1 indicates the two planes of axle 1. Solid, straight arrows on one axle plane indicate impetus exerted on axle 1.

Energy source 7 energizes rotational motor 4 which engages drive gear 3a to turn rotor 3 in the direction indicated by the circular arrows. Energy control 6 sends power to truck motors 5a when the leading arm of rotor 3 crosses the dashed plane line. This activates truck motors 5a to turn pinion gear 5b against stationary rack gear 3b. Ballasted truck assembly 5 on the leading arm of rotor 3 then travels to the outermost position from axle 1. At the same time, energy control 6 also sends power to truck assembly 5 on the trailing arm of rotor 3 to move to the innermost position to axle 1. As rotor 3 continues to turn, truck assemblies 5 will alternate position each time the arms of rotor 3 cross the dashed plane line. Truck assembly 5 acts as a weighted member due to the heaviness of a motor assembly. The mass of ballasted truck assembly 5 serves as a load against which centrifugal and rotational inertia will act.

With rotor 3 turning, the centrifugal energy exerted on truck assembly 5 positioned at the outermost point from axle 1 is greater than the centrifugal energy exerted on truck assembly 5 positioned closest to axle 1. The consistency of truck assembly 5 at the outermost position for half of a complete rotation while the opposing truck is at the innermost position, will cause an imbalance of rotor 3 which will exert greater force to one side of axle 1 and less force to the other side of axle 1. The solid arrows extending from the dashed plane line show the impetus transmitted to axle 1 and therefore, framework 2 when truck assemblies 5 are under rotation in the positions indicated.

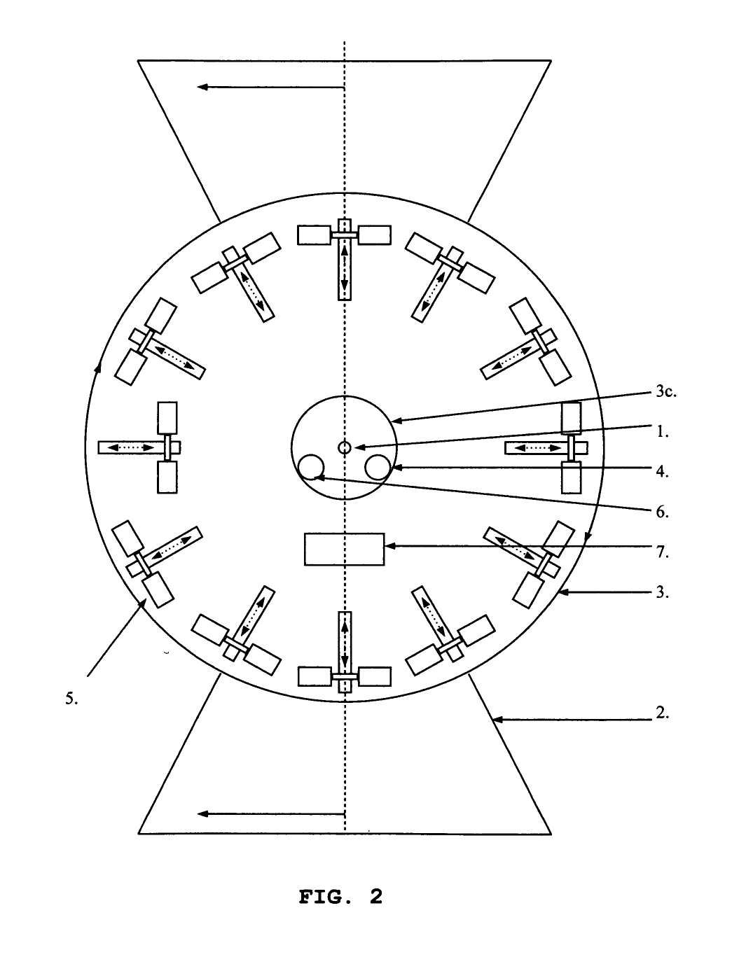

### Description—FIG. 2—First Alternative Embodiment

In FIG. 2, all components retain their respective numbers. Configuration of rotor 3 is now circular to accommodate multiple ballasted truck assembly 5. Depiction of track 3a is omitted for clarity. Directional arrows and dashed line depicting planes remain the same.

### Operation—FIG. 2—First Alternative Embodiment

In this first alternative embodiment, the inertia of the centrifuge is acted on in a different manner than that of the preferred embodiment. FIG. 2 shows multiple truck assembly 5. The default position for all trucks is at the outermost position on rotor 3. This causes an equal balance on axle 1 and imputes no directional thrust. As rotor 3 spins, outward forces are generated on truck assembly 5. In this embodiment, truck assembly 5 pulls inward against that force, exerting more impetus on one side of axle 1 than the opposite side of axle 1.

Energy control 6 sends power to truck assembly 5 in the leading position as rotor 3 spins. Truck assembly 5 in the leading position is drawn inward against centrifugal forces and is shown in the drawing at its innermost position. As that assembly travels past that point in the rotation of rotor 3, it reverts to the outermost position and the following truck assembly 5 is activated and pulled to its innermost position. This action is constant throughout the rotation. These bursts of energy opposing and overcoming the centrifugal forces exerted against the truck assemblies create a directional impetus on axle 1, causing it to draw toward the retracting trucks that are creating a greater opposing force than the static trucks.

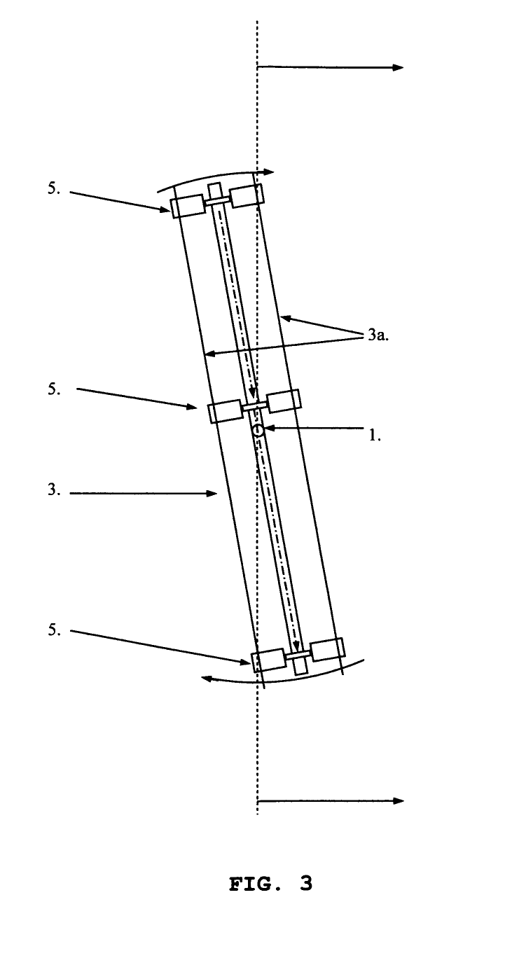

### Description—FIG. 3—Second Alternative Embodiment

In FIG. 3, all components retain their respective numbers. Configuration of rotor 3 is non-circular. Depiction of framework 2 and rotational drive components as well as energy components have been omitted for clarity. Ballasted truck assembly 5 is singular, but shown in three progressive positions in the course of its travel as indicated by arrows with a broken line.

### Operation—FIG. 3—Second Alternative Embodiment

The second alternative embodiment works on the directional inertia exerted on truck assembly 5 rather than outward centrifugal inertia. In this embodiment, truck assembly 5 completely crosses from one side of rotor 3 to the other. The drawing shows the same truck assembly 5 in three successive positions. With truck assembly 5 located at the outermost position on rotor 3, it is subject to a comparatively insignificant degree of centrifugal force.

Truck assembly 5 achieves a forward inertia as it travels the half rotation at the outermost position on rotor 3. As truck assembly 5 passes the plane line, it is activated similarly to the previous embodiments. Truck assembly 5 abruptly travels on track 3a toward axle 1. The rotational inertia of truck assembly 5 is completely arrested at that point it intersects axle 1. This exerts a pulling force on axle 1 equivalent to the momentum truck assembly 5 had gained during rotation. As truck assembly 5 continues to the opposite side of rotor 3, it has no inertia or possibly a small degree of inertia in the opposing direction. The motion of rotor 3 forces truck assembly 5 back into rotation. As truck assembly 5 is urged into motion, its mass resists, which causes an impetus to be exerted on axle 1. This impetus is the same direction as the pull previously induced by the arresting of the rotational inertia of truck assembly 5. In this embodiment, directional thrust is induced to axle 1 by arresting and then restarting the rotational inertia of truck assembly 5 as it travels across rotor 3.

### CONCLUSION, RAMIFICATIONS, AND SCOPE

The advantages of the Mechanism for Generating Directional Thrust from a Centrifuge are many. It is a completely novel way of generating thrust. The present invention would be ideally suited for vehicles as it requires no drive apparatus such as a wheel, blade, or stream of gasses. It also requires no braking apparatus. Motion or force is induced to a frame simply from the forces of imbalance working on an axle. Cars, planes, trains all utilize drive mechanisms that transfer power from an engine to surfaces or atmospheres. The present invention can provide thrust directly to a frame or vehicle without any need of a drive mechanism. A reversal or change of angle of thrust would logically serve as a braking and directional mechanism.

While suitable as a profound improvement over complex, heavy engines and drive trains in mechanisms that travel on an X/Y plane, the most unique capability of this invention would be in terms of providing either levitation or super gravity. Helicopters and rockets can move in the Z plane. They are loud, dangerous and completely subject to the atmosphere they must operate against. The present invention is capable of generating forces far above those of gravity. An upward thrusting imbalance could easily levitate a payload and/or a vehicle. The same vehicle with an X/Y thrusting imbalance could then travel in any direction without the aid of a jet or propeller. A payload could be hoisted and maneuvered without the need of a crane. A downward thrusting imbalance could provide a light vehicle with substantial weight upon demand, or be used to compress or anchor materials without need of heavy machinery.

The present invention could make roadways obsolete, revolutionize personal transportation, transform airline and space travel. Even for use in ground-based vehicles, the savings of fuel currently needed to move heavy, complex engines, the frameworks they necessitate, and drive-trains would be immense.

Without the need to act against surfaces or atmosphere, a vehicle propelled and/or levitated by centrifugal imbalance could be constructed to be silent. This would provide huge military advantage in stealth, and access for transportation of troops and weaponry.

The potential of this previously undiscovered method of creating force and propulsion would change the world in ways too numerous to explore. These ramifications address but a few of the major benefits presently considered as probable for the invention.

Although the drawings and descriptions of the present invention indicate electric drive motors as the means of altering the balance of a centrifuge, the operational possibilities are virtually limitless. Actual means of altering balance may consist of, but not be limited to: mechanical interaction, lineal and rotational electric motors, solenoids, actuators, hydraulics, pneumatics, or combustion. The drawings included are indicated to be top views of the embodiments. The same embodiments could be utilized in a vertical, rather than horizontal position. They could also then be rotated a quarter turn to illustrate function in a Z plane. The drawings could be interpreted to serve as side views of the invention under these circumstances.

Although the description above contains many specificities, these should not be construed as limiting the scope of the invention, but as merely providing illustrations of some of the presently considered embodiments of the device. The explanations of centrifugal force, inertia, and imbalance are not intended to be technically comprehensive, but adequate to illustrate the basic principles of operation of the present invention. The scope of this invention includes any means of induced imbalance or altered inertia applied to a centrifuge to generate directional thrust. The scope of the present invention should be determined by the appended claims and their legal equivalents, rather than limited by the examples given.

I claim:

1. A mechanism for generating directional thrust from a centrifuge, comprising:
a support means to align and unite the members,
at least one spindle means affixed to said support,
a rotor means capable of rotating on said spindle,
a means of spinning said rotor,
a means of imputing an imbalance to said spinning rotor,
whereby, a greater impetus is consistently exerted on one side of a spindle than the other to impute omni-directional thrust to a spindle and subsequently a framework to provide propulsion or force.

2. The support means of claim 1, wherein said support means includes a framework that can support the members.

3. The spindle means of claim 1, wherein said spindle means includes an axle that is affixed to said framework.

4. The centrifuge means of claim 1, whereby said centrifuge includes a rotor that is capable of acting on said axle means.

5. The spinning means of claim 1, whereby said spinning means includes a motor that acts on said rotor to produce rotation.

6. The imbalance means of claim 1, whereby said imbalance means includes a ballasted member capable of acting on a rotor in a manner whereby the balance of a spinning rotor is consistently augmented on one side of an spindle and reduced on the other side of the same spindle in a rotation to produce directional thrust on a spindle thereby imputing motion or force to a framework.
